(19) United States
(12) Patent Application Publication
(10) Pub. No.: US 2026/0278821 A1
(43) Pub. Date: Sep. 17, 2026

(54) DIGITAL TWIN HEIGHT ESTIMATION

(71) Applicant: QUALCOMM Incorporated, San Diego, CA (US)

(72) Inventors: Alexis Marie GEHRKE, San Diego, CA (US); Nikolai Konrad LEUNG, San Francisco, CA (US)

(21) Appl. No.: 19/082,095

(22) Filed: Mar. 17, 2025

(51) Int. Cl. G06T 7/60; G02B 27/01; G06V 10/60; G06V 20/17

(52) U.S. Cl. CPC G06T 7/60; G02B 27/017; G06V 10/60; G06V 20/17

(57) ABSTRACT

Systems and techniques are described herein for determining building heights. For example, a computing device can process one or more aerial images to determine heights of a first set of one or more buildings associated with a first area of an environment based on a length of shadows of the first set of one or more buildings represented in the one or more aerial images. The computing device can determine, based on the heights of the first set of one or more buildings, heights of a second set of one or more buildings.

### FIELD

Aspects of the present disclosure generally relate to height estimation techniques of objects in a real-world environment for generation of a digital twin representation of the real-world environment. For example, aspects of the present disclosure relate to systems and techniques for digital twin height estimation.

### BACKGROUND

Wireless networks can vary in range based on the environment in which the wireless network is located. Objects within the environment can affect the range of wireless network infrastructure, such as by affecting the range of routers, signal boosters, internet of things (IoT) devices, user equipment (UE), cell towers, and other telecommunications infrastructure to facilitate the wireless network. Network designers must account for how the environment or objects in the environment impacts ranges and signal quality of the wireless network when determining where to place the wireless network infrastructure. Generating a digital twin representation of an environment can be used simulate where to place infrastructure, to test changes to the wireless network, or to simulate and troubleshoot network issues in a wireless network.

Obtaining accurate height data for objects in an environment can be challenging on a large scale, such as for a town, city, or other community. Existing online data sources do not always provide height information for all areas within a community. Additionally, many ground-level images are insufficient for estimating the height of taller buildings, such as buildings which may not be completely represented in the image or images lacking requisite information regarding time and date the image was taken.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, an apparatus for determining building heights is provided. The apparatus includes at least one memory and at least one processor coupled to the at least one memory and configured to: determine heights of a first set of one or more buildings associated with a first area of an environment based on a length of shadows of the first set of one or more buildings represented in one or more aerial images; and determine, based on the heights of the first set of one or more buildings, heights of a second set of one or more buildings.

In some aspects, a method for determining building heights is provided. The method includes: determining heights of a first set of one or more buildings associated with a first area of an environment based on a length of shadows of the first set of one or more buildings represented in one or more aerial images; and determining, based on the heights of the first set of one or more buildings, heights of a second set of one or more buildings.

In some aspects, a non-transitory computer-readable medium is provided having stored thereon instructions that, when executed by at least one processor, cause the at least one processor to: determine heights of a first set of one or more buildings associated with a first area of an environment based on a length of shadows of the first set of one or more buildings represented in one or more aerial images; and determine, based on the heights of the first set of one or more buildings, heights of a second set of one or more buildings.

In some aspects, an apparatus for determining building heights is provided. The apparatus includes: means for determining heights of a first set of one or more buildings associated with a first area of an environment based on a length of shadows of the first set of one or more buildings represented in one or more aerial images; and means for determining, based on the heights of the first set of one or more buildings, heights of a second set of one or more buildings.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example implementation of a system-on-a-chip (SOC), in accordance with aspects of the present disclosure;

FIG. 2 is a block diagram illustrating an example of determining height of a building based on a shadow cast by the building, in accordance with aspects of the present disclosure;

FIGS. 3A-3D are flow diagrams illustrating an iterative process for determining heights of buildings using the shadows of the buildings, in accordance with aspects of the present disclosure;

FIG. 4 is a block diagram illustrating an example dependency tree map representation of the height of buildings, in accordance with aspects of the present disclosure;

FIG. 5 is a flow diagram illustrating an example process for determining heights of buildings based on shadows cast by the building, in accordance with aspects of the present disclosure;

FIG. 6 is a block diagram illustrating an example neural network, in accordance with aspects of the present disclosure;

FIG. 7 is a block diagram illustrating an example convolutional neural network, in accordance with aspects of the present disclosure;

FIG. 8 is a block diagram illustrating example computing device architecture of an example computing device which can implement the various techniques described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As mentioned, wireless networks can vary in range based on the environment in which the wireless network is located. Objects within the environment can affect the range of wireless network infrastructure, such as by affecting the range of routers, signal boosters, internet of things (IoT) devices, user equipment (UE), cell towers, and other telecommunications infrastructure to facilitate the wireless network. Network designers must account for how the environment or objects in the environment impacts ranges and signal quality of the wireless network when determining where to place the wireless network infrastructure. Generating a digital twin representation of an environment can be used simulate where to place infrastructure, to test changes to the wireless network, or to simulate and troubleshoot network issues in a wireless network.

Obtaining accurate height data for objects in an environment can be challenging on a large scale, such as for a town, city, or other community. Existing online data sources do not always provide height information for all areas within a community. Additionally, many ground-level images are insufficient for estimating the height of taller buildings, such as buildings which may not be completely represented in the image or images lacking requisite information regarding time and date the image was taken.

A digital twin can be a virtual representation of a real-world environment. For example, a digital twin can include a digital (e.g., two-dimensional representation, three-dimensional representation, etc.) representation of the real-world environment and objects in the real-world environment. Digital twins can be constructed by a computing device using various data sources such as aerial images, ground level images, geographical data, environmental data, municipal building documents, etc.

Digital twins can be used for wireless network design, such as to determine where to place infrastructure. For example, in city environments, the locations of buildings, water towers, trees, etc. can impact a wireless network, such as by creating dead zones. Further, population data associated with the location of buildings can indicate population density or areas where populations congregate, such as at popular landmarks, businesses, offices, etc. Designers designing wireless networks can consider the environment, objects in the environment, and the people within the environment when determining where to place wireless network infrastructure.

For example, digital twins can be used for wireless ray tracing in channel modeling and network planning, such as base station placement and determining handoff boundaries. Digital twins used in wireless network planning generally require precise height information of objects in the environment (such as buildings, landmarks, etc.) to accurately predict the impact of buildings and tree foliage on signal propagation.

Systems, apparatuses, electronic devices, methods (also referred to as processes), and computer-readable media (collectively referred to herein as “systems and techniques”) are described herein for determining digital twin heights. For example, the systems and techniques are described herein for estimating heights of objects in a real-world environment for use in a digital twin representation of the environment. In a further example, the systems and techniques are described herein for estimating heights of buildings within an environment based on shadows of the buildings and other information associated with the building to use in constructing a digital twin representation of the real-world environment.

In some aspects, the systems and techniques can include iteratively using height estimation techniques based on computational resources used to estimate the heights of objects, such as but not limited to buildings. For example, the systems and techniques can use an iterative process to determine the heights of buildings, beginning with a least computational resource intensive operation. The systems and techniques can include using the iterative process to determine additional buildings whose heights can be determined based on the height information of other buildings. In such an example, the systems and techniques can conserve computational resources by determining building heights based on heights of previously estimated buildings.

In some aspects, the systems and techniques can include determining heights of buildings based on documents such as municipal records, building records, blueprints, etc. For example, the systems and techniques can scrape the documents from a data source. In some examples, the data source is a server or database of the documents, such as a database of municipal records. The systems and techniques can include using various scraping techniques, such as screen scraping, Hypertext Markup Language (HTML), Document Object Model (DOM) parsing, natural language processing (NLP), etc. to determine height information of the buildings from the documents. In some examples, the documents can be text files, image files, etc.

In some aspects, the systems and techniques can scrape the data source using a machine learning model. For example, the machine learning model can be a neural network, large language model (LLM), etc. trained to scrape information from documents or other data. For example, the machine learning model can be trained to perform natural language processing of documents to identify heights of buildings from documents such as municipal records, blueprints, etc.

In some aspects, the systems and techniques can include determining heights of buildings based on aerial images. For example, the systems and techniques can include obtaining aerial images, such as satellite imagery, airplane imagery, etc. The systems and techniques can include determining heights of the buildings based on the length of the shadows cast by the buildings in the aerial images. For example, the systems and techniques can include identifying buildings and corresponding shadows represented in the aerial images. The aerial images can include annotations or metadata indicating when the image was taken (e.g., date and time of day) and where the image was taken (e.g., angle, position and orientation of the image sensor, etc.). In such an example, the date and time of day can indicate angle of the sun relative to the building. In such an example, the angle of the sun and an estimated length of the shadow can be used to estimate the height of the building.

In some examples, the systems and techniques can include image processing techniques for determining the length of shadows from aerial images. For example, the aerial images can be from a satellite. The systems and techniques can use various image analysis techniques to determine the length of shadows from the aerial images. In one example, pixel characteristics of the aerial images can be mapped to real-world lengths (e.g., real-world distances such as one pixel is mapped to one meter, etc.). The systems and techniques can use a pixel length of the shadows represented in the aerial images to determine the length of the shadows.

In such an example, the systems and techniques can use trigonometric relationships between the shadow and the building casting the shadow to estimate the height of the building. For example, when the time and date an image is taken is known, the position of the sun is also known. For example, the systems and techniques can include determining from annotations or metadata of images, a time and date the image was generated (e.g., taken). The systems and techniques can include providing the information to a celestial body tracking application or service, to determine a position of the sun within the sky when the image was generated.

In such an example, the position of the sun within the sky can be represented as an angle from a point on Earth (e.g., at the location of a building or at an end of the shadow). The systems and techniques can use the angle and the determined length of the shadow to determine the height of the building casting the shadow. For example, the trigonometric relationship between the shadow, the sun angle, and the building height can be represented as tan

$$( θ ) = \frac{h}{s}$$

where θ represents an angle of the sun to the building, h represents a height of the building, and s represents a length of the shadow cast by the building.

In some aspects, the systems and techniques can include determining the height of buildings using ground level images. For example, the systems and techniques use the trigonometric relationship represented as

$$tan ( θ ) = \frac{h}{s}$$

to determine the height of a building using ground level images including shadows of the building. In some examples, the systems and techniques can include using image processing techniques, such as the image processing techniques used to determine the length of the shadows, to determine the width of a first building casting a shadow to determine the length of shadow of a second building.

For example, second building could be obscured in an aerial photo, or the shadow the second building not measurable because of nearby buildings or objects preventing the length of the shadow to be measured using an aerial image. In such an example, the width of a nearby building (e.g., a nearby building represented in the ground level images casting a respective shadow) can be used to estimate the shadow cast by another building. The estimated shadow can then be used to estimate the height of the second building. In such an example, the systems and techniques can include using various image processing techniques to re-scale a first building represented in a ground level image to the scale of the second image whose height is to be determined (e.g., as if the first building and the second building were represented in the ground level image on substantially even ground substantially the same distance from the image sensor). In such an example, the length of the shadow can be compared to the known width of the first building. For example, the systems and techniques can use image processing techniques to determine what proportion of the first building the length of the shadow cast by the second building is. When the systems and techniques determine the length of the shadow cast by the second building, the systems and techniques can include using the trigonometric relationship

$$( tan ( θ ) = \frac{h}{s} )$$

to determine the height of the second building.

In some aspects, the systems and techniques can include populating a building dependency tree map representation with estimated heights of buildings. The building dependency tree map representation can be a visual representation of buildings within an area (e.g., a region) of the environment which have been estimated in height. In some examples, the building dependency tree map representation can be a spreadsheet, document, or data structure representing the height estimation techniques used to estimate heights of buildings in an environment, and buildings which remain to be estimated in height.

For example, the dependency tree map representation can be used to determine which buildings have height estimations based on aerial photos, ground level photos, scraped information regarding height, etc. and buildings whose heights were estimated based on the height of nearby buildings (e.g., building 1 is substantially the same height as building 2, therefore estimations of the height of building 1 can be used for the estimation of height of building 2, etc.). In some examples, the systems and techniques can include determining buildings (referred to as root buildings) which can be used to determine heights of additional buildings (referred to as leaf buildings).

In some aspects, the systems and techniques can include estimating heights of buildings with complex roof shapes. In such an example, the systems and techniques can use a plurality of images (e.g., aerial images or ground level images) to determine a maximum shadow length cast by the building. In such an example, the maximum shadow length can be used to determine the height of the building.

In some aspects, the systems and techniques can include identifying buildings whose height was not estimated (or not able to be estimated) using the aerial images, scraping documents, or the ground-level images. In such an example, the systems and techniques can include generating a request to a user to generate an image (e.g., take a photo) of the building. In some examples, the instructions can be a request received by a user on his or her phone or on a head mounted device (HMD) such as smart glasses, extended reality (XR) headset, etc. In some examples, the systems and techniques can transmit the request to a user nearby the building whose height is to be estimated. For example, the systems and techniques can geo-tag an area and when a user enters the geo-tagged area, the systems and techniques can request the user take a photo of the building. In further examples, the systems and techniques can include transmitting instructions to a drone (e.g., an unmanned aerial vehicle (UAV)) to travel to the building and take the photo (e.g., an aerial image or ground level image).

Various aspects of the systems and techniques described herein will be discussed below with respect to the figures.

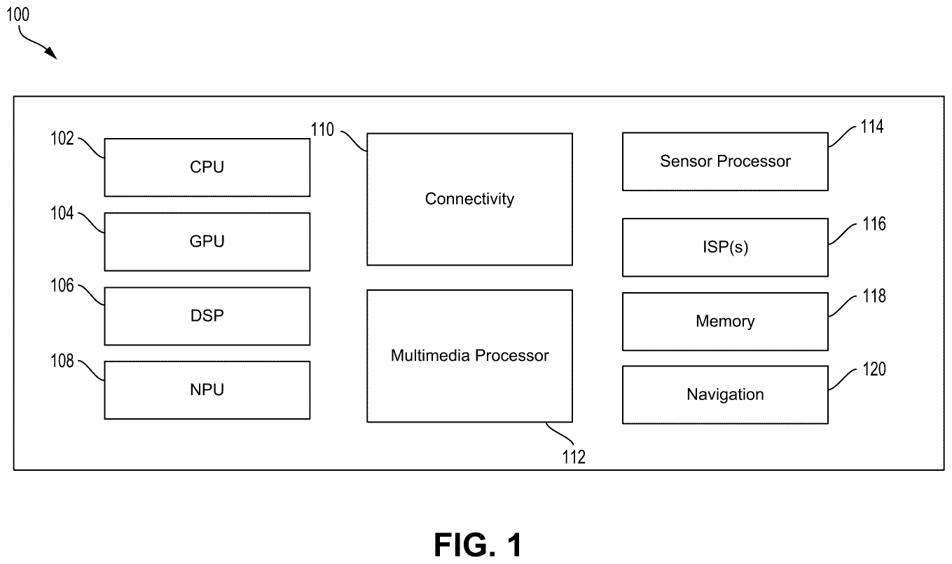

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize audio signals. In one implementation, the NPU is implemented in the CPU 102, DSP 106, and/or GPU 104. The SOC 100 may also include one or more sensors 114 such as but not limited to one or more microphones, image signal processors (ISPs) 116, and/or storage 120.

The SOC 100 may be based on an ARM instruction set. In an aspect of the present disclosure, the instructions loaded into the CPU 102 may comprise code to search for a stored multiplication result in a lookup table (LUT) corresponding to a multiplication product of an input value and a filter weight. The instructions loaded into the CPU 102 may also comprise code to disable a multiplier during a multiplication operation of the multiplication product when a lookup table hit of the multiplication product is detected. In addition, the instructions loaded into the CPU 102 may comprise code to store a computed multiplication product of the input value and the filter weight when a lookup table miss of the multiplication product is detected.

SOC 100 and/or components thereof may be configured to perform audio processing, such as denoising audio signals of wind noise, using machine learning techniques according to aspects of the present disclosure discussed herein. For example, SOC 100 and/or components thereof may be configured to perform processing techniques such as but not limited to: segment shifting, shuffle correlation, gain shifting, segment masking, and additional processing techniques. SOC 100 can be part of a computing device or multiple computing devices. In some examples, SOC 100 can be part of an electronic device (or devices) such as an audio recording device, camera system (e.g., a digital camera, an IP camera, a video camera, a security camera, etc.), a telephone system (e.g., a smartphone, a cellular telephone, a conferencing system, etc.), a desktop computer, an XR device (e.g., a head-mounted display, etc.), a smart wearable device (e.g., a smart watch, smart glasses, etc.), a laptop or notebook computer, a tablet computer, a set-top box, a television, a display device, a system-on-chip (SoC), a digital media player, a gaming console, a video streaming device, a server, a drone, a computer in a car, an Internet-of-Things (IoT) device, or any other suitable electronic device(s).

In some implementations, the CPU 102, the GPU 104, the DSP 106, the NPU 108, the connectivity block 110, the multimedia processor 112, the one or more sensors 114, the ISPs 116, the memory block 118 and/or the storage 120 can be part of the same computing device. For example, in some cases, the CPU 102, the GPU 104, the DSP 106, the NPU 108, the connectivity block 110, the multimedia processor 112, the one or more sensors 114, the ISPs 116, the memory block 118 and/or the storage 120 can be integrated into a smartphone, laptop, tablet computer, smart wearable device, video gaming system, server, and/or any other computing device. In other implementations, the CPU 102, the GPU 104, the DSP 106, the NPU 108, the connectivity block 110, the multimedia processor 112, the one or more sensors 114, the ISPs 116, the memory block 118 and/or the storage 120 can be part of two or more separate computing devices.

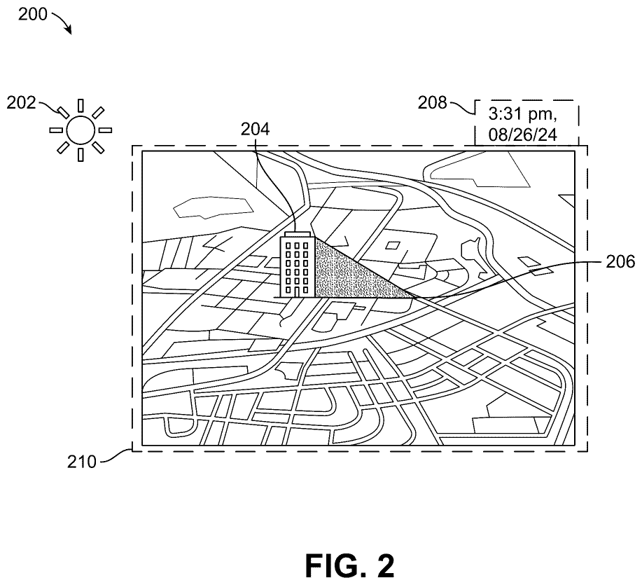

The SOC 100 of FIG. 1 can be used to perform various operations of such as the shadow estimation, image processing, and height estimation techniques described in the descriptions of FIGS. 2, 3A-3D, 4, and 5.

FIG. 2 is a block diagram 200 illustrating an example of using a shadow 206 to estimate a height of a building 204. For example, block diagram 200 includes an image 210 of the building 204 and the shadow 206 cast by the building 204. The image 210 can be an aerial view image (also referred to as aerial image) or ground-level view image of an environment such as a city. The image 210 includes metadata 208 indicating when the image 210 was generated. In some examples, the metadata 208 can include information such as where the image 210 was taken (e.g., angle, position and orientation of the image sensor, etc.). In such an example, the date and time of day can indicate angle of the sun 202 relative to the building 204. A computing device can be used to use trigonometric relationships between the angle of the sun 202, the building 204, and the shadow 206 to determine the height of the building 204.

Based on the metadata 208, a computing device, such as the SOC 100 of FIG. 1, can determine the angle of the sun 202 when the image 210 was generated. The SOC 100 can use various image processing techniques to determine the length of the shadow 206.

For example, a computing device such the SOC 100 of FIG. 1 can determine heights of buildings based on the image 210 and corresponding metadata 208. For example, the computing device can obtain images (such as image 210), such as satellite imagery, airplane imagery, etc. In such an example, the computing device can use image processing techniques to identify buildings (such as building 204) and shadows (e.g., shadow 206) corresponding to the buildings represented in the image 210.

Various image analysis techniques can be used to determine the length of the shadow 206 from the image 210. In one example, pixel characteristics of the image 210 can be mapped to real-world lengths (e.g., real-world distances such as one pixel is mapped to one meter, etc.). The length of the shadow 206 can be determined based on the number of pixels representing the shadow 206 in the image 210.

The length of the shadow 206 can be used to determine the height of the building 204. For example, the trigonometric relationship of the shadow 206, the angle of the sun 202, and the height of the building 204 can be represented as

$$tan ( θ ) = \frac{h}{s}$$

where θ represents an angle of the sun 202 to the building 204, h represents a height of the building 204, and s represents a length of the shadow 206 cast by the building 204.

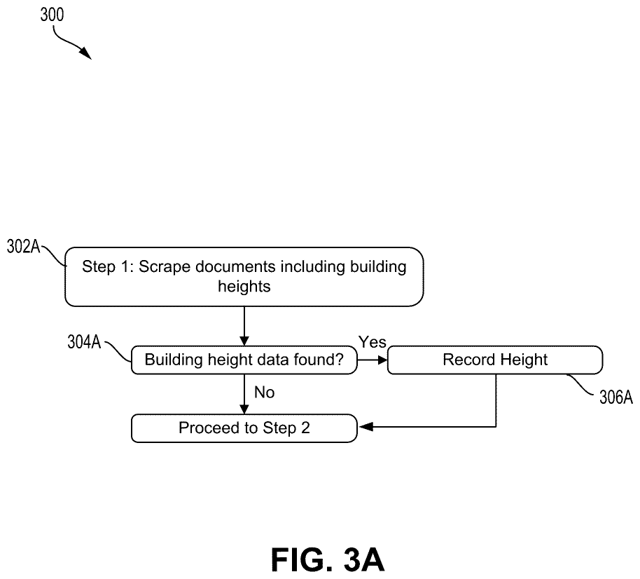

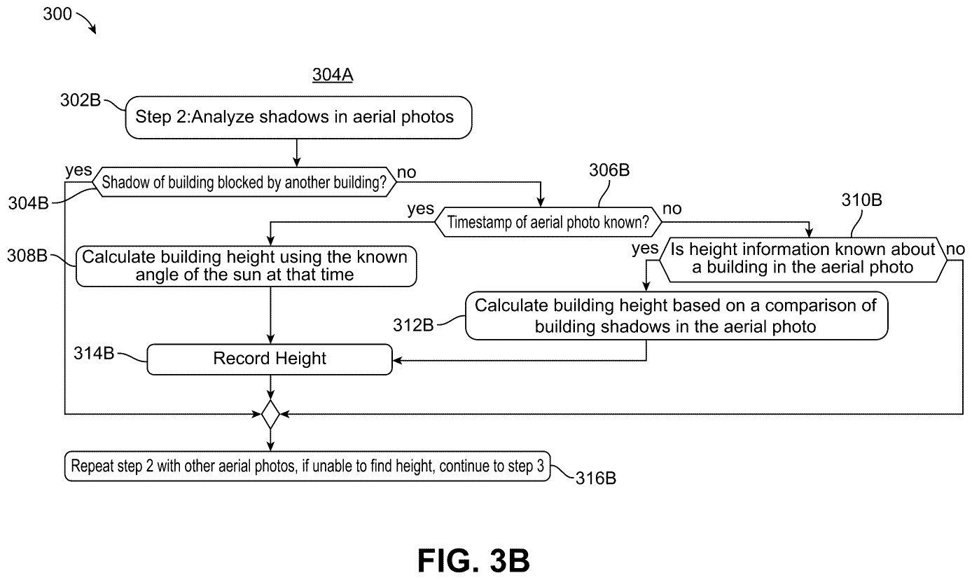

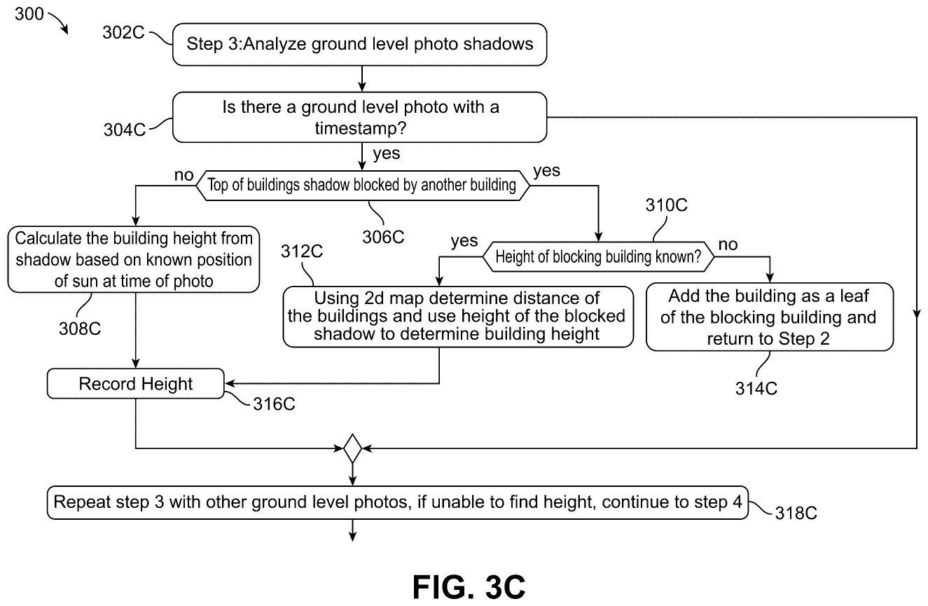

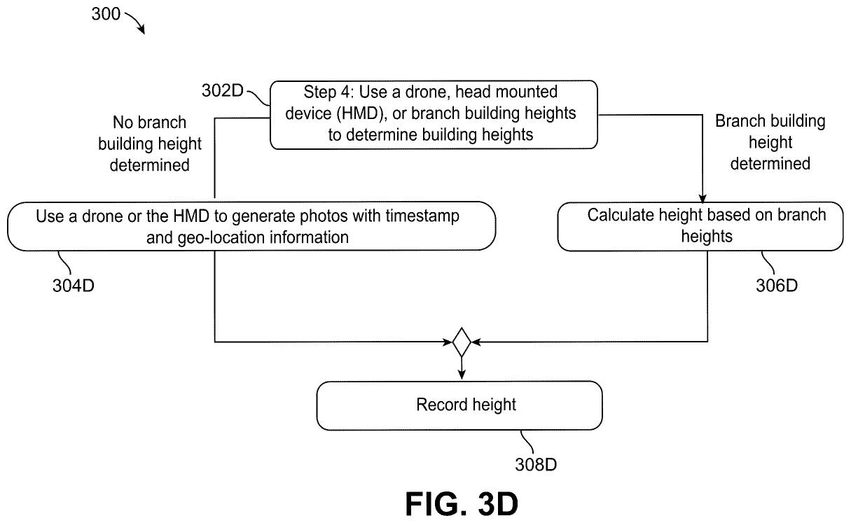

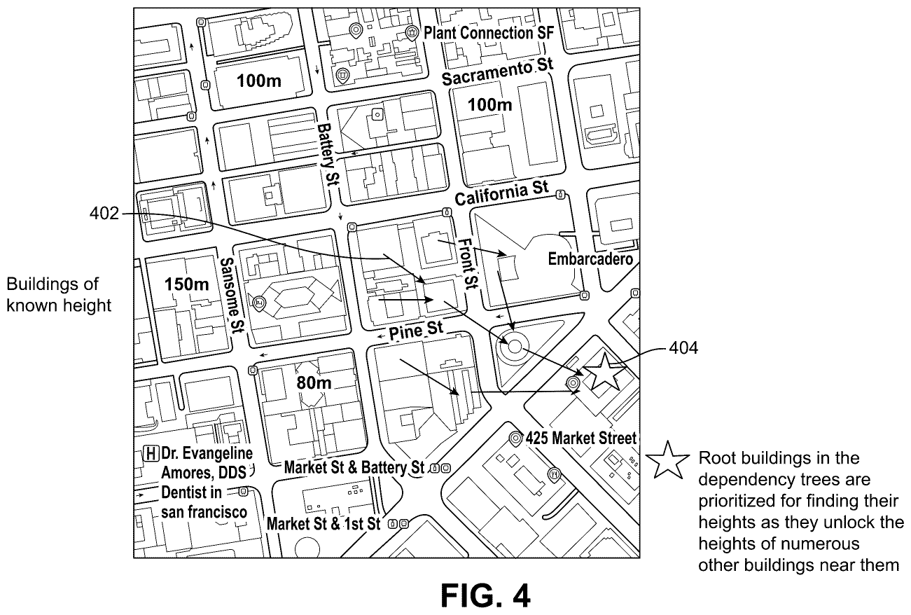

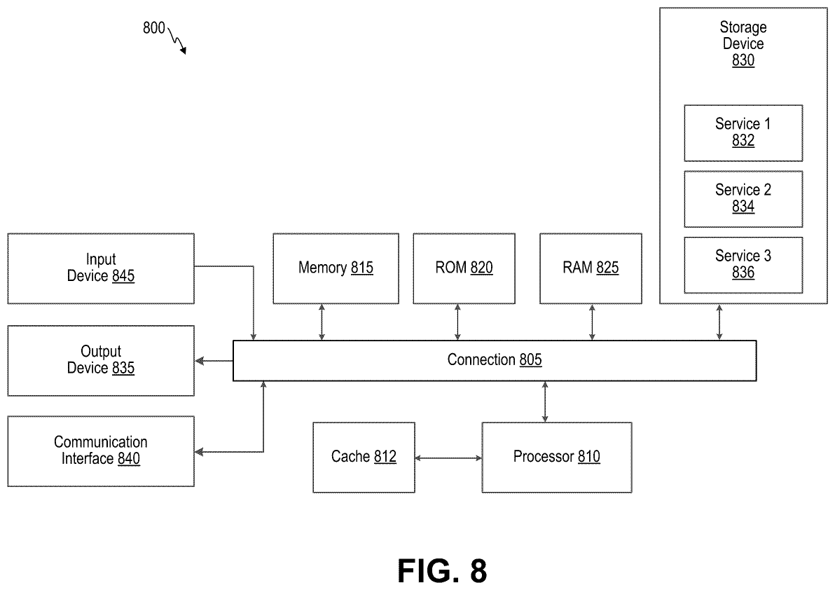

FIGS. 3A-3D are flow diagrams illustrating an iterative process 300 for using height estimation techniques to determine heights of buildings based on shadows of the buildings and information scraped about the buildings. The estimated heights (also referred to as determined heights) can be used to populate a dependency tree map representation such as the dependency tree map representation 400 of FIG. 4. The iterative process 300 can be represented as a sequence of steps (e.g., step 1, step 2, step 3, and step 4), however in some examples, the order of the steps can be rearranged, steps added, or steps omitted. Further, in some examples the steps can be divided into sub-steps. The process 300 can be performed using the SOC 100 of FIG. 1, the computing system 800 of FIG. 8, or other systems, computing devices, etc. described herein.

FIG. 3A illustrates iterative process 300 at step 1, which includes scraping documents to determine heights of buildings. For example, iterative process 300 can include block 302A. At block 302A, a computing device (or component thereof) can scape documents (e.g., municipal building permits, blueprints, etc.) including building heights. For example, the computing device (or component thereof) can use a program, script, or other automated process to scrape municipal building permits from a data source. For example, the data source can be a server, database, or repository of information associated with buildings in an area.

At block 304A, the computing device (or component thereof) can determine whether height data is found (e.g., present) in the scraped documents. For example, the computing device can use a machine learning model, such as an LLM, to scrape the documents and perform natural language processing (NLP) to identify heights of buildings provided in the scraped documents. When the machine learning model (or the computing device) determines building height information is in the documents, the process 300 can proceed to block 306A. When the machine learning model (or the computing device) determines building height information is not provided in the scraped documents, the computing device (or component thereof) can proceed to step 2 (e.g., represented as block 302B in FIG. 3B).

At block 306A, the computing device (or component thereof) can record the heights of building identified in the scraped documents in a dependency tree map representation such as the dependency tree map representation 400 of FIG. 4. For example, the computing device (or component thereof) can populate the dependency tree map representation with the heights recorded in the scraped documents. When the computing device (or component thereof) records the heights from the documents in the dependency tree map representation, the computing device (or component thereof) can proceed to step 2 (e.g., represented as block 302B in FIG. 3B).

FIG. 3B is a flow diagram illustrating iterative process 300 at step 2, which includes analyzing shadows in aerial photos (e.g., aerial images). For example, the iterative process 300 can include block 302B. At block 302B, the computing device (or component thereof) can analyze shadows in aerial photos. For example, the computing device can use various image processing techniques to analyze the shadows in aerial photos, such as pixel-by-pixel image processing techniques to analyze pixel characteristics (e.g., brightness, color, etc.) to identify shadows and buildings from the aerial photo.

At block 304B, the computing device (or component thereof) can determine whether the shadow of a building whose height is to be estimated is block by another building. For example, some buildings in densely populated cities can be close enough to other buildings that the shadow cast by the buildings is obstructed by another building, landmark, object, etc. When the shadow of the building is blocked, the computing device (or component thereof) can proceed to block 316B. When the shadow of the building is not blocked, the computing device (or component thereof) can determine the length of the shadow using various image processing techniques and can proceed to block 306B.

At block 306B, the computing device (or component thereof) can determine whether the aerial photo includes a timestamp (e.g., metadata or annotation) indicating when the aerial photo was taken. For example, the timestamp can include a time and date of the aerial photo being taken. When the aerial photo includes a time stamp, the computing device can proceed to block 308B, otherwise the computing device can proceed to block 310B.

At block 308B, the computing device (or component thereof) can calculate building heights using the known angle of the sun at the time of the timestamp from the aerial photo and using the length of the shadow determined at block 304B. For example, computing device (or component thereof) can calculate the angle of the sun or receive sun angle information from celestial body tracking service or application. The building height can be represented as a trigonometric relationship between the angle of the sun and the length of the shadow cast by the building. For example, the building height can be represented as

$$tan ( θ ) = \frac{h}{s}$$

where θ represents an angle of the sun to the building, h represents a height of the building, and s represents a length of the shadow cast by the building.

At block 310B, the computing device (or component thereof) can determine whether height information is known about another building in the aerial photo (such as an adjacent building, a nearby building, etc.). For example, the computing device can use the known heights of other buildings in the aerial image to determine the heights of buildings when a timestamp is not provided for the aerial photo. For example, the aerial photo can include an aerial view of a building whose height was determined during step 1 (e.g., scraped from documents). When the computing device determines the height of another building is known (e.g., from step 1), the computing device can proceed to block 312B.

At block 312B, the computing device (or component thereof) can calculate building heights based on a comparison of building shadows in the aerial photo. For example, because the height of nearby buildings is determined (e.g., from step 1 or another step), the height of other buildings can be determined without knowing the angle of the sun. For example, the height of the building can be determined from a proportion of the known building height and shadow length. When the computing device determines the height of the building, the computing device can proceed to block 314B.

At block 314B, the computing device (or component thereof) can record the heights of buildings calculated using the aerial photos in a dependency tree map representation such as the dependency tree map representation 400 of FIG. 4. For example, the computing device (or component thereof) can populate the dependency tree map representation with the heights calculated using the aerial photos (e.g., the heights calculated at blocks 308B and 312B). When the computing device (or component thereof) records the heights from the documents in the dependency tree map representation, the computing device (or component thereof) can proceed to block 316B.

At block 316B, the computing device (or component thereof) can iterate through additional aerial photos to perform the operations described in blocks 302B-314B. When the computing device (or component thereof) is unable to determine additional building heights from the aerial photos, the computing device (or component thereof) can proceed to step 3 (e.g., represented as block 302C in FIG. 3C).

FIG. 3C is a flow diagram illustrating iterative process 300 at step 3, which includes analyzing shadows in the ground level photos (e.g., aerial images). For example, the iterative process 300 can include block 302C. At block 302C, the computing device (or component thereof) can analyze ground level photo shadows. For example, the computing device (or component thereof) can obtain one or more ground level photos of buildings (e.g., buildings in the area represented in aerial photos). For example, the computing device can use various image processing techniques to analyze the shadows in the ground level photos, such as pixel-by-pixel image processing techniques to analyze pixel characteristics (e.g., brightness, color, etc.) to identify shadows and buildings from the aerial photo.

At block 304C, the computing device (or component thereof) can determine whether the ground level photo includes a timestamp. For example, the timestamp can include a date and time when the ground level photo was taken. In such an example, the position of the sun can be determined based on the date and time. When the ground level photo includes a timestamp, the computing device can proceed to block 306C, otherwise the computing device can proceed to block 320C.

At block 306C, the computing device (or component thereof) can determine whether the top of a building shadow (e.g., a building whose height is to be determined) is blocked by another building. For example, when the top of the shadow is not blocked by another building, computing device can determine the height of the building based on the trigonometric relationship between the angle of the sun, the building height, and the shadow length at block 308C. From block 308C the computing device can proceed to block 316C to record the building heights in a dependency tree map representation. When the top of the shadow is blocked by another building, the computing device can proceed to block 310C to determine whether the height of the building casting the blocked shadow is known. When the height is known, the computing device can proceed to block 312C. When the height is not known, the computing device or component thereof can proceed to block 314C.

At block 310C, the computing device (or component thereof) can determine whether the height of the building blocking the top of the shadow from block 306C is known. For example, the computing device (or component thereof) can reference the dependency tree map representation to determine whether the height of the building blocking the top of the shadow is known and recorded in the dependency tree map representation. When the height is known, the computing device can proceed to block 312C, otherwise (e.g., when the height is undetermined) the computing device can proceed to block 314C.

At block 312C, the computing device (or component thereof) can use a two-dimensional map to determine distance of the buildings represented in the ground level photo and use the height of the building blocking the shadow to determine the height of the building with the blocked shadow. For example, the computing device can use various image processing to determine the length of the shadow blocked by the blocking building. The length of shadow blocked by the blocking building can be added to the unblocked portion of the shadow to determine a total length of the shadow. The computing device can use the total shadow length and angle of the sun determined using the timestamp to determine the height of the building. The computing device can record the height of the building at block 316C.

In some examples, the computing device (or component thereof) can determine distances between a target building (e.g., the building height to be estimated) and a blocking building (e.g., the building which blocks the shadow of the target building) based on a two-dimensional map including the buildings (e.g., a map with distances between buildings). In such an example, the computing device can use the distances between the buildings and scale of the buildings to one another to determine the height of a casted shadow of the blocking building using the known blocking building height and computer vision estimation.

At block 314C, the computing device (or component thereof) can add the building whose shadow is blocked as another building as a leaf building of the blocking building. A leaf building is a building whose height can be determined after determining the height of another building (e.g., a root building). The computing device (or component thereof) can return to step 2 (e.g., block 302B of FIG. 3B).

At block 316C, the computing device (or component thereof) can record the heights of buildings calculated using the ground level photos in a dependency tree map representation such as the dependency tree map representation of FIG. 4. For example, the computing device (or component thereof) can populate the dependency tree map representation with the heights calculated using the ground level photos (e.g., the heights calculated at blocks 308C and 312C). When the computing device (or component thereof) records the heights from the documents in the dependency tree map representation, the computing device (or component thereof) can proceed to block 318C.

At block 318C, the computing device (or component thereof) can iterate through additional ground level photos to perform the operations described in blocks 302C-316C. When the computing device (or component thereof) is unable to determine additional building heights from the ground level photos, the computing device (or component thereof) can proceed to step 4 (e.g., represented as block 302D in FIG. 3D).

FIG. 3D is a flow diagram illustrating iterative process 300 at step 4, which includes using a drone, HMD (e.g., an augmented reality (AR) headset), or other device with an image sensor (e.g., a camera) to generate additional aerial photos or ground level photos to use to determine the heights of buildings based on whether a branch building height is determined (such as determined in Steps 1-3 of FIGS. 3A-3C). For example, a branch building can be a building which when the height is determined, additional building heights can be determined. For example, when the height of a first building is known, the height of a second building is not known, and a scale of the first building to the second building is determined, the height of the second building can be determined from the height of the first building and the scale. In such an example, the first building can be a branch building of the second building. The iterative process 300 can include block 302D. At block 302D, the computing device (or component thereof) can use a drone or HMD to obtain additional ground level photos or aerial photos or determine the height of buildings based on branch building heights. For example, the computing device (or component thereof) can generate instructions to a user using an HMD or a drone to take a photo of a building whose height is to be measured.

At block 304D, the computing device (or component thereof) can determine to use a drone or the HMD to generate photos with timestamp and geo-location information. In such an example, the computing device (or component thereof) can use the drone or the HMD when no branch building height is determined which can otherwise be used to determine the height of the building to be photographed. In some examples, the computing device can generate instructions to generate photos of root buildings of a dependency tree map representation. The determined heights of the branch buildings (or root building which can be a first building which additional branch building heights are determined from) can be used to determine the heights of leaf buildings (e.g., buildings whose height estimation using the aforementioned techniques is based on using height information of the branch building). The heights of the buildings determined at block 304D can be recorded in the dependency tree map representation at block 308D.

At block 306D, the computing device (or component thereof) can calculate the height of buildings based on branch building heights. For example, when a branch building height is known (such as building heights determined in steps 1-3 of FIGS. 3A-3C) the computing device (or component thereof) can calculate the height of buildings based on the determined building heights of the branch buildings. For example, when the scale of two buildings is known (e.g., a proportion of the height between a first building of a determined height and a second building of an undetermined height), the height of the buildings can be determined based on the scale. The heights of the buildings determined at block 306D can be recorded in the dependency tree map representation at block 308D.

FIG. 4 is a block diagram illustrating an example dependency tree map representation 400. In some examples, the dependency tree map representation 400 is a visual representation of buildings in a region (e.g., an area) of an environment. For example, the dependency tree map representation 400 can be represented as an image, a spreadsheet, a document, or data object indicating the dependencies of building height estimation calculations on determining other building heights. For example, buildings represented in images without timestamps or with blocked shadows can be determined based on determining the heights of nearby buildings or based on determining the heights of buildings blocking the shadows. The dependency tree map representation 400 can be used to track the dependencies height estimations of buildings. By way of example, arrows 402 can indicate a building whose height can be used to determine the heights of other nearby buildings, such as the building to which the arrow points. The dependency tree map representation can include root buildings (e.g., root building 404), which can represent a building that can be used to determine the heights of a plurality of buildings (e.g., a set of one or more buildings). from the building dependency tree map representation 400.

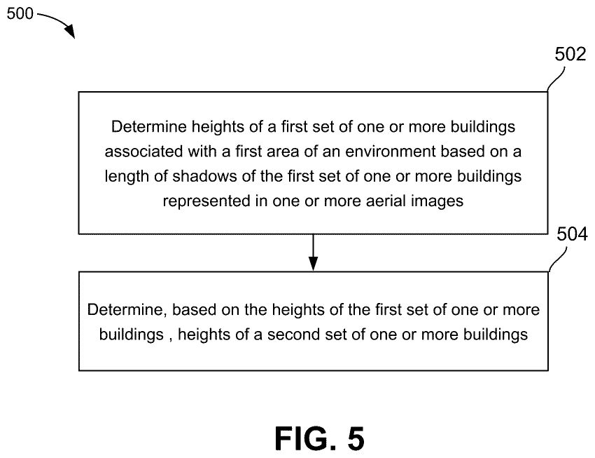

FIG. 5 is a flow diagram illustrating an example process 500 for determining building heights. In particular, the process 500 illustrates an example process of determining building heights to generate a digital twin of an environment. The process 500 can be performed by a computing device (e.g., the SOC 100 of FIG. 1, the computing device or computing system 800 of FIG. 8, etc.) or by a component or system, a chipset, one or more processors central processing units (CPUs), digital signal processors (DSPs), graphics processing units (GPUs), any other type of processor(s), any combination thereof, or other component or system) of the computing device. The operations of the process 500 can be implemented as software components that are executed and run on one or more processors (e.g., the CPU 102, the GPU 104, the DSP 106, the NPU 108 of FIG. 1, the processor 810 of FIG. 8, or other processor(s)) of the computing device.

At block 502, the computing device (or component thereof) can determine heights of a first set of one or more buildings associated with a first area of an environment based on a length of shadows of the first set of one or more buildings represented in one or more aerial images. For example, the one or more aerial images can be aerial images from a satellite or aerial craft (e.g., a drone, a plane, helicopter, etc.). In some examples, the aerial images can include annotations indicating when the image was generated. For example, the aerial images can include annotations (or metadata) indicating a date and time of when the aerial images were generated. In some examples, the computing device (or component thereof) can used various image processing techniques to determine a length of the shadows of the first set of one or more buildings represented in the one or more aerial images.

At block 504, the computing device (or component thereof) can determine, based on the heights of the first set of one or more buildings, heights of a second set of one or more buildings. In some examples, the second set of one or more buildings can be represented in the one or more aerial images. In further examples, the heights of the second plurality can be determined based on a comparison of the shadows of the first set of one or more buildings and the shadows of the second set of one or more buildings. In such an example, the shadows of the first set of one or more buildings can be a ratio of the shadows of the second set of one or more buildings. For example, the second set of one or more buildings can be determined as casting a shadow two-thirds of the length of the shadows of the first set of one or more buildings. In such an example, when the first set of one or more buildings is 300 feet high, the second set of one or more buildings can be determined to be 200 feet high.

In some aspects, the computing device (or component thereof) can process a plurality of documents to determine heights of a third set of one or more buildings associated with a second area of the environment. In such an example, the computing device (or component thereof) can use a machine learning model to scrape the plurality of documents from a data source (e.g., a database, repository, etc.) of building height records to collect the plurality of documents (or the height information from the plurality of documents). In some examples, the data source is a municipal database of building records. In further examples, the machine learning model can be a large language model (LLM). In another example, the computing device (or component thereof) can receive, from a data source, the plurality of documents. For example, the computing device (or component thereof) can receive the plurality of documents (or building height information) from a data source such as a repository, database, server, etc. In some examples, the computing device can communicate with the data source using a Representational State Transfer (RES) architecture such as a RESTful application programming interface (API) or REST API. In other examples, the computing device can receive the plurality of documents (or building height information) as a JavaScript Object Notation (JSON) data structure. In some examples, the computing device (or component thereof) can determine, based on the heights of the first set of one or more buildings and heights of the third set of one or more buildings, heights of a fourth set of one or more buildings.

In some aspects, the computing device (or component thereof) can generate a dependency tree map representation of the heights of buildings of a third set of one or more buildings based on images of the third set of one or more buildings. For example, the dependency tree map representation can be the dependency tree map representation 400 of FIG. 4. In such an example, the dependency tree map representation can indicate buildings of the third set of one or more buildings used to determine the heights of one or more buildings from a fourth set of one or more buildings. In further examples, the computing device (or component thereof) can identify, based on the dependency tree map representation, one or more buildings with an undetermined height. In such an example, the computing device (or component thereof) can generate a request to obtain an additional image of the one or more buildings with the undetermined height. For example, the request can include instructions for a user using a head mounted device (HMD) to generate the additional image using an image sensor of the HMD. In further examples, the request can include instructions to an aerial drone generate an aerial view image using an image sensor of the aerial drone. In another example, the computing device (or component thereof) can process one or more ground level images of the third set of one or more buildings to determine heights of the third set of one or more buildings associated with the first area of the environment based on a length of shadows of the third set of one or more buildings represented in the one or more ground level images.

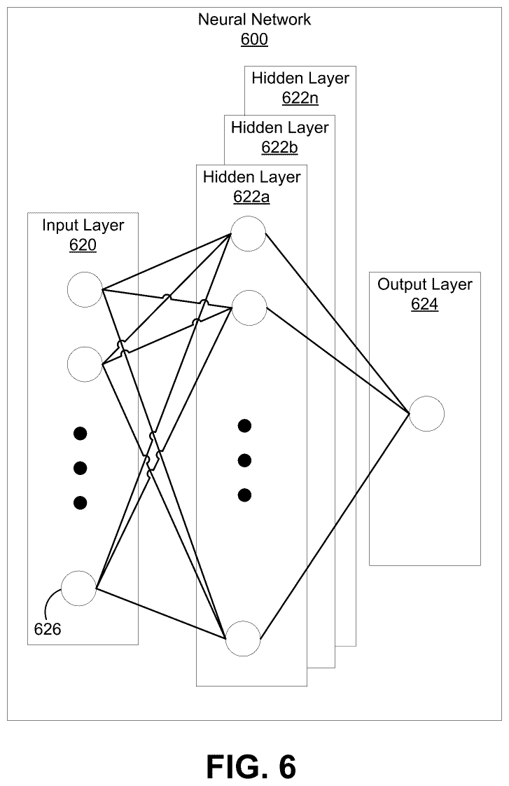

As noted above, various aspects of the present disclosure can use machine learning models or systems. FIG. 6 is an illustrative example of a deep learning neural network 600 that can be used to implement the machine learning based feature extraction and/or activity recognition (or classification) described above. An input layer 620 includes input data. In one illustrative example, the input layer 620 can include data representing the pixels of an input video frame. The neural network 600 includes multiple hidden layers 622a, 622b, through 622n. The hidden layers 622a, 622b, through 622n include “n” number of hidden layers, where “n” is an integer greater than or equal to one. The number of hidden layers can be made to include as many layers as needed for the given application. The neural network 600 further includes an output layer 624 that provides an output resulting from the processing performed by the hidden layers 622a, 622b, through 622n.

The neural network 600 is a multi-layer neural network of interconnected nodes. Each node can represent a piece of information. Information associated with the nodes is shared among the different layers and each layer retains information as information is processed. In some cases, the neural network 600 can include a feed-forward network, in which case there are no feedback connections where outputs of the network are fed back into itself. In some cases, the neural network 600 can include a recurrent neural network, which can have loops that allow information to be carried across nodes while reading in input.

Information can be exchanged between nodes through node-to-node interconnections between the various layers. Nodes of the input layer 620 can activate a set of nodes in the first hidden layer 622a. For example, as shown, each of the input nodes of the input layer 620 is connected to each of the nodes of the first hidden layer 622a. The nodes of the first hidden layer 622a can transform the information of each input node by applying activation functions to the input node information. The information derived from the transformation can then be passed to and can activate the nodes of the next hidden layer 622b, which can perform their own designated functions. Example functions include convolutional, up-sampling, data transformation, and/or any other suitable functions. The output of the hidden layer 622b can then activate nodes of the next hidden layer, and so on. The output of the last hidden layer 622n can activate one or more nodes of the output layer 624, at which an output is provided. In some cases, while nodes (e.g., node 626) in the neural network 600 are shown as having multiple output lines, a node has a single output and all lines shown as being output from a node represent the same output value.

In some cases, each node or interconnection between nodes can have a weight that is a set of parameters derived from the training of the neural network 600. Once the neural network 600 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 600 to be adaptive to inputs and able to learn as more data is processed.

The neural network 600 can be pre-trained to process the features from the data in the input layer 620 using the different hidden layers 622a, 622b, through 622n in order to provide the output through the output layer 624.

In some cases, the neural network 600 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until the neural network 600 is trained well enough so that the weights of the layers are accurately tuned.

For the example of reducing noise in audio signals, the forward pass can include passing training data through the neural network 600. The weights are initially randomized before the neural network 600 is trained. As an illustrative example, an audio signal can include an array of numbers representing a sequence of sounds. Each number in the array can include a numerical value representing sounds in sequence. In one example, the array is a one-dimensional sequence of numbers.

As noted above, for a first training iteration for the neural network 600, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 600 is unable to determine low level features and thus cannot make an accurate determination of what the classification of the object might be. A loss function can be used to analyze error in the output. Another example of a loss function includes the mean squared error (MSE), defined as

$${E}_{total} = \sum \frac{1}{2} {( target - output )}^{2} .$$

The loss can be set to be equal to the value of Eₜₒₜₐₗ.

The loss (or error) will be high for the first training data since the actual values will be much different than the predicted output. The goal of training is to minimize the amount of loss so that the predicted output is the same as the training label. The neural network 600 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wi denotes the initial weight, and n denotes a learning rate. The learning rate can be set to any suitable value, with a high learning rate including larger weight updates and a lower value indicating smaller weight updates.

The neural network 600 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. The neural network 600 can include any other deep network other than a CNN, such as an autoencoder, a deep belief nets (DBNs), a Recurrent Neural Networks (RNNs), among others.

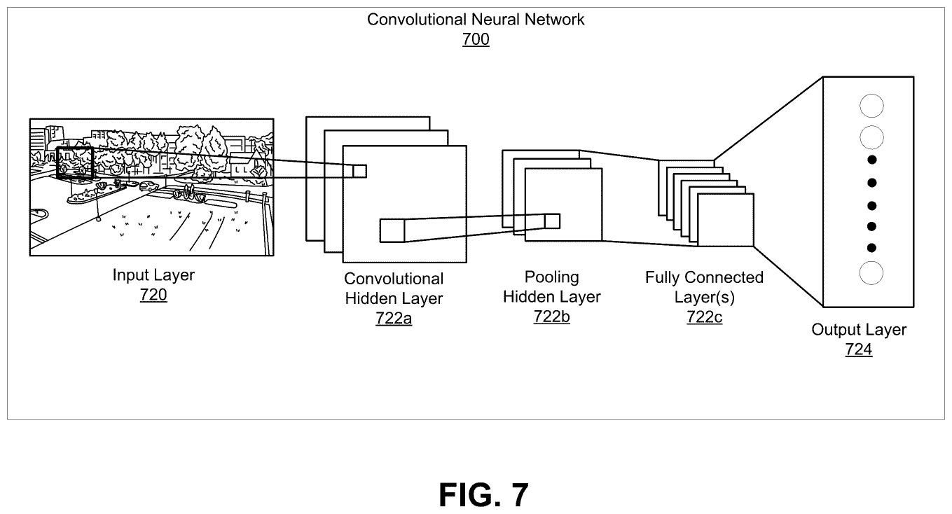

FIG. 7 is an illustrative example of a convolutional neural network (CNN) 1000. FIG. 7 provides an example for operation of a convolutional neural network (CNN) 1000 on images and video, however the structure of the convolutional neural network (CNN) may be further adapted to receive one-dimensional inputs such as audio signals. The input layer 720 of the CNN 700 includes data representing an image or frame. For example, the data can include an array of numbers representing the pixels of the image, with each number in the array including a value from 0 to 255 describing the pixel intensity at that position in the array. For example, the array can include a 28×28×3 array of numbers with 28 rows and 28 columns of pixels and 3 color components (e.g., red, green, and blue, or luma and two chroma components, or the like). The image can be passed through a convolutional hidden layer 722a, an optional non-linear activation layer, a pooling hidden layer 722b, and fully connected hidden layers 722c to get an output at the output layer 724. While only one of each hidden layer is shown in FIG. 7, one of ordinary skill will appreciate that multiple convolutional hidden layers, non-linear layers, pooling hidden layers, and/or fully connected layers can be included in the CNN 700. The output can indicate a single class of an object or can include a probability of classes that best describe the object in the image.

The first layer of the CNN 700 is the convolutional hidden layer 722a. The convolutional hidden layer 722a analyzes the image data of the input layer 720. Each node of the convolutional hidden layer 722a is connected to a region of nodes (pixels) of the input image called a receptive field. The convolutional hidden layer 722a can be considered as one or more filters (each filter corresponding to a different activation or feature map), with each convolutional iteration of a filter being a node or neuron of the convolutional hidden layer 722a. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 722a. Each connection between a node and a receptive field for that node learns a weight and, in some cases, an overall bias such that each node learns to analyze its particular local receptive field in the input image. Each node of the hidden layer 722a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 722a is due to each node of the convolutional layer being applied to its corresponding receptive field. For example, a filter of the convolutional hidden layer 722a can begin in the top-left corner of the input image array and can convolve around the input image. As noted above, each convolutional iteration of the filter can be considered a node or neuron of the convolutional hidden layer 722a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 722a. For example, a filter can be moved by a step amount (referred to as a stride) to the next receptive field. The stride can be set to 1 or another suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 722a.

The mapping from the input layer to the convolutional hidden layer 722a is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 722a can include several activation maps in order to identify multiple features in an image. The example shown in FIG. 7 includes three activation maps. Using three activation maps, the convolutional hidden layer 722a can detect three different kinds of features, with each feature being detectable across the entire image.

In some examples, a non-linear hidden layer can be applied after the convolutional hidden layer 722a. The non-linear layer can be used to introduce non-linearity to a system that has been computing linear operations. One illustrative example of a non-linear layer is a rectified linear unit (ReLU) layer. A ReLU layer can apply the function f(x)=max (0, x) to all of the values in the input volume, which changes all the negative activations to 0. The ReLU can thus increase the non-linear properties of the CNN 700 without affecting the receptive fields of the convolutional hidden layer 722a.

The pooling hidden layer 722b can be applied after the convolutional hidden layer 722a (and after the non-linear hidden layer when used). The pooling hidden layer 722b is used to simplify the information in the output from the convolutional hidden layer 722a. For example, the pooling hidden layer 722b can take each activation map output from the convolutional hidden layer 722a and generates a condensed activation map (or feature map) using a pooling function. Max-pooling is one example of a function performed by a pooling hidden layer. Other forms of pooling functions be used by the pooling hidden layer 722a, such as average pooling, L2-norm pooling, or other suitable pooling functions. A pooling function (e.g., a max-pooling filter, an L2-norm filter, or other suitable pooling filter) is applied to each activation map included in the convolutional hidden layer 722a. In the example shown in FIG. 7, three pooling filters are used for the three activation maps in the convolutional hidden layer 722a.

In some examples, max-pooling can be used by applying a max-pooling filter (e.g., having a size of 2×2) with a stride (e.g., equal to a dimension of the filter, such as a stride of 2) to an activation map output from the convolutional hidden layer 722a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 722a having a dimension of 24×24 nodes, the output from the pooling hidden layer 722b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

Intuitively, the pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 700.

The final layer of connections in the network is a fully-connected layer that connects every node from the pooling hidden layer 722b to every one of the output nodes in the output layer 724. Using the example above, the input layer includes 28×28 nodes encoding the pixel intensities of the input image, the convolutional hidden layer 722a includes 3×24×24 hidden feature nodes based on application of a 5×5 local receptive field (for the filters) to three activation maps, and the pooling hidden layer 722b includes a layer of 3×12×12 hidden feature nodes based on application of max-pooling filter to 2×2 regions across each of the three feature maps. Extending this example, the output layer 724 can include ten output nodes. In such an example, every node of the 3×12×12 pooling hidden layer 722b is connected to every node of the output layer 724.

The fully connected layer 722c can obtain the output of the previous pooling hidden layer 722b (which should represent the activation maps of high-level features) and determines the features that most correlate to a particular class. For example, the fully connected layer 722c layer can determine the high-level features that most strongly correlate to a particular class and can include weights (nodes) for the high-level features. A product can be computed between the weights of the fully connected layer 722c and the pooling hidden layer 722b to obtain probabilities for the different classes. For example, if the CNN 700 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 724 can include an M-dimensional vector (in the prior example, M=10). M indicates the number of classes that the CNN 700 can choose from when classifying the sounds in an audio recording. Other example outputs can also be provided. Each number in the M-dimensional vector can represent the probability the object is of a certain class. In one illustrative example, if a 10-dimensional output vector represents ten different classes of sounds is [0 0 0.05 0.8 0 0.15 0 0 0 0], the vector indicates that there is a 5% probability that the audio includes a third class of sound (e.g., a trumpet), an 80% probability that the audio includes a fourth class of sound (e.g., a human voice), and a 15% probability that the audio includes a sixth class of sound (e.g., a bird chirping). The probability for a class can be considered a confidence level that the object is part of that class.

FIG. 8 is a diagram illustrating an example of a system for implementing certain aspects of the present technology. In particular, FIG. 8 illustrates an example of computing system 800, which may be for example any computing device making up internal computing system, a remote computing system, a camera, or any component thereof in which the components of the system are in communication with each other using connection 805. Connection 805 may be a physical connection using a bus, or a direct connection into processor 810, such as in a chipset architecture. Connection 805 may also be a virtual connection, networked connection, or logical connection.

In some aspects, computing system 800 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 800 includes at least one processing unit (CPU or processor) 810 and connection 805 that communicatively couples various system components including system memory 825, such as read-only memory (ROM) 820 and random access memory (RAM) 825 to processor 810. Computing system 800 may include a cache 812 of high-speed memory connected directly with, in close proximity to, or integrated as part of processor 810.

Processor 810 may include any general-purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which may represent any number of input mechanisms, such as a microphone for speech, a touch-sensitive screen for gesture or graphical input, keyboard, mouse, motion input, speech, etc. Computing system 800 may also include output device 835, which may be one or more of a number of output mechanisms. In some instances, multimodal systems may enable a user to provide multiple types of input/output to communicate with the computing system 800.

Computing system 800 may include communications interface 840, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 830 may include software services, servers, services, etc., that when the code that defines such software is executed by the processor 810, it causes the system to perform a function. In some aspects, a hardware service that performs a particular function may include the software component stored in a computer-readable medium in connection with the necessary hardware components, such as processor 810, connection 805, output device 835, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:
Aspect 1. An apparatus for determining building heights, comprising: at least one memory; and at least one processor coupled to the at least one memory, the at least one processor configured to: determine heights of a first set of one or more buildings associated with a first area of an environment based on a length of shadows of the first set of one or more buildings represented in one or more aerial images; and determine, based on the heights of the first set of one or more buildings, heights of a second set of one or more buildings.
Aspect 2. The apparatus of Aspect 1, wherein the at least one processor is further configured to: process a plurality of documents to determine heights of a third set of one or more buildings associated with a second area of the environment; and determine, based on the heights of the first set of one or more buildings and heights of the third set of one or more buildings, heights of a fourth set of one or more buildings.
Aspect 3. The apparatus of any of Aspects 1 to 2, wherein the at least one processor is further configured to: receive, from a data source, the plurality of documents.
Aspect 4. The apparatus of any of Aspects 1 to 3, wherein the at least one processor is further configured to: scrape, using a machine learning model, a data source to collect the plurality of documents.
Aspect 5. The apparatus of any of Aspects 1 to 4, wherein the data source is a municipal database of building records.
Aspect 6. The apparatus of any of Aspects 1 to 5, wherein the one or more aerial images includes annotations indicating a date and time of the one or more aerial images.
Aspect 7. The apparatus of any of Aspects 1 to 6, wherein the at least one processor is further configured to: generate a dependency tree map representation of the heights of buildings from images of a third set of one or more buildings used to determine the heights of one or more buildings from a fourth set of one or more buildings.
Aspect 8. The apparatus of any of Aspects 1 to 7, wherein the at least one processor is further configured to: identify, based on the dependency tree map representation, one or more buildings with an undetermined height; and generate a request to obtain an additional image of the one or more buildings with the undetermined height.
Aspect 9. The apparatus of any of Aspects 1 to 8, wherein the request includes instructions for a user using a head mounted device (HMD) to generate the additional image using an image sensor of the HMD.
Aspect 10. The apparatus of any of Aspects 1 to 9, wherein the request includes instructions to an aerial drone generate an aerial view image using an image sensor of the aerial drone.
Aspect 11. The apparatus of any of Aspects 1 to 10, wherein the at least one processor is further configured to: process one or more ground level images of the third set of one or more buildings to determine heights of the third set of one or more buildings associated with the first area of the environment based on a length of shadows of the third set of one or more buildings represented in the one or more ground level images.
Aspect 12. A method for determining building heights, the method comprising: determining heights of a first set of one or more buildings associated with a first area of an environment based on a length of shadows of the first set of one or more buildings represented in one or more aerial images; and determining, based on the heights of the first set of one or more buildings, heights of a second set of one or more buildings.
Aspect 13. The method of Aspect 12, further comprising: processing a plurality of documents to determine heights of a third set of one or more buildings associated with a second area of the environment; and determining, based on the heights of the first set of one or more buildings and heights of the third set of one or more buildings, heights of a fourth set of one or more buildings.
Aspect 14. The method of any of Aspects 12 to 13, further comprising: receiving, from a data source, the plurality of documents.
Aspect 15. The method of any of Aspects 12 to 14, further comprising: scraping, using a machine learning model, a data source to collect the plurality of documents.
Aspect 16. The method of any of Aspects 12 to 15, wherein the data source is a municipal database of building records.
Aspect 17. The method of any of Aspects 12 to 16, wherein the one or more aerial images includes annotations indicating a date and time of the one or more aerial images.
Aspect 18. The method of any of Aspects 12 to 17, further comprising: generating a dependency tree map representation of the heights of buildings from images of a third set of one or more buildings used to determine the heights of one or more buildings from a fourth set of one or more buildings.
Aspect 19. The method of any of Aspects 12 to 18, further comprising: identifying, based on the dependency tree map representation, one or more buildings with an undetermined height; and generating a request to obtain an additional image of the one or more buildings with the undetermined height.
Aspect 20. The method of any of Aspects 12 to 19, wherein the request includes instructions for a user using a head mounted device (HMD) to generate the additional image using an image sensor of the HMD.
Aspect 21. The method of any of Aspects 12 to 20, wherein the request includes instructions to an aerial drone generate an aerial view image using an image sensor of the aerial drone.
Aspect 22. The method of any of Aspects 12 to 21, further comprising: processing one or more ground level images of the third set of one or more buildings to determine heights of the third set of one or more buildings associated with the first area of the environment based on a length of shadows of the third set of one or more buildings represented in the one or more ground level images.
Aspect 23. A non-transitory computer-readable medium having stored thereon instructions that, when executed by at least one processor, cause the at least one processor to perform one or more of operations according to any of Aspects 12 to 22.
Aspect 24. An apparatus for wireless communication, the apparatus comprising one or more means for performing operations according to any of Aspects 12 to 12.

What is claimed is:

1. An apparatus for determining building heights, comprising:
at least one memory; and
at least one processor coupled to the at least one memory, the at least one processor configured to:
determine heights of a first set of one or more buildings associated with a first area of an environment based on a length of shadows of the first set of one or more buildings represented in one or more aerial images; and
determine, based on the heights of the first set of one or more buildings, heights of a second set of one or more buildings.

2. The apparatus of claim 1, wherein the at least one processor is further configured to:
process a plurality of documents to determine heights of a third set of one or more buildings associated with a second area of the environment; and
determine, based on the heights of the first set of one or more buildings and heights of the third set of one or more buildings, heights of a fourth set of one or more buildings.

3. The apparatus of claim 2, wherein the at least one processor is further configured to:
receive, from a data source, the plurality of documents.

4. The apparatus of claim 2, wherein the at least one processor is further configured to:
scrape, using a machine learning model, a data source to collect the plurality of documents.

5. The apparatus of claim 4, wherein the data source is a municipal database of building records.

6. The apparatus of claim 1, wherein the one or more aerial images includes annotations indicating a date and time of the one or more aerial images.

7. The apparatus of claim 1, wherein the at least one processor is further configured to:
generate a dependency tree map representation of the heights of buildings from images of a third set of one or more buildings used to determine the heights of one or more buildings from a fourth set of one or more buildings.

8. The apparatus of claim 7, wherein the at least one processor is further configured to:
identify, based on the dependency tree map representation, one or more buildings with an undetermined height; and
generate a request to obtain an additional image of the one or more buildings with the undetermined height.

9. The apparatus of claim 8, wherein the request includes instructions for a user using a head mounted device (HMD) to generate the additional image using an image sensor of the HMD.

10. The apparatus of claim 8, wherein the request includes instructions to an aerial drone generate an aerial view image using an image sensor of the aerial drone.

11. The apparatus of claim 8, wherein the at least one processor is further configured to:
process one or more ground level images of the third set of one or more buildings to determine heights of the third set of one or more buildings associated with the first area of the environment based on a length of shadows of the third set of one or more buildings represented in the one or more ground level images.

12. A method for determining building heights, the method comprising:
determine heights of a first set of one or more buildings associated with a first area of an environment based on a length of shadows of the first set of one or more buildings represented in one or more aerial images; and
determining, based on the heights of the first set of one or more buildings, heights of a second set of one or more buildings.

13. The method of claim 12, further comprising:
processing a plurality of documents to determine heights of a third set of one or more buildings associated with a second area of the environment; and
determining, based on the heights of the first set of one or more buildings and heights of the third set of one or more buildings, heights of a fourth set of one or more buildings.

14. The method of claim 13, further comprising:
receiving, from a data source, the plurality of documents.

15. The method of claim 13, further comprising:
scraping, using a machine learning model, a data source to collect the plurality of documents.

16. The method of claim 15, wherein the data source is a municipal database of building records.

17. The method of claim 12, wherein the one or more aerial images includes annotations indicating a date and time of the one or more aerial images.

18. The method of claim 12, further comprising:
generating a dependency tree map representation of the heights of buildings from images of a third set of one or more buildings used to determine the heights of one or more buildings from a fourth set of one or more buildings.

19. The method of claim 18, further comprising:
identifying, based on the dependency tree map representation, one or more buildings with an undetermined height; and
generating a request to obtain an additional image of the one or more buildings with the undetermined height.

20. A non-transitory computer-readable medium having stored thereon instructions that, when executed by at least one processor, cause the at least one processor to:
determine heights of a first set of one or more buildings associated with a first area of an environment based on a length of shadows of the first set of one or more buildings represented in one or more aerial images; and
determine, based on the heights of the first set of one or more buildings, heights of a second set of one or more buildings.
